(19) United States
(12) Patent Application Publication
(10) Pub. No.: US 2008/0276192 A1
(43) Pub. Date: Nov. 6, 2008

(54) Method and apparatus for controlling an electromagnetic energy output system

(75) Inventors: Jeffrey W. Jones, Robertson, WY (US); Dmitri Boutoussov, Dana Point, CA (US)

Correspondence Address: STOUT, UXA, BUYAN & MULLINS LLP, 4 VENTURE, SUITE 300, IRVINE, CA, 92618, US

(73) Assignee: BIOLASE Technology, Inc.

(21) Appl. No.: 11/820,746

(22) Filed: Jun. 19, 2007

Related U.S. Application Data
(63) Continuation-in-part of application No. 11/800,434, filed on May 3, 2007.
Application No. 11/800,434 is a continuation-in-part of application No. 11/800,435, filed on May 3, 2007.
(60) Provisional application No. 60/932,409, filed on May 30, 2007.

(51) Int. Cl. G06F 3/048

(52) U.S. Cl. 715/772

(57) ABSTRACT

A graphical user interface is described that controls an electromagnetic energy output system. A touchscreen presents control icons and receives input from a user; the input being used to control the electromagnetic energy output system. The interface permits modifying stored values of preset operating parameters.

### CROSS-REFERENCE TO RELATED APPLICATIONS

This application claims the benefit of U.S. Provisional Application No. 60/932,409, filed May 30, 2007 and entitled METHOD AND APPARATUS FOR CONTROLLING AN ELECTROMAGNETIC ENERGY OUTPUT SYSTEM (Att. Docket BI9975CIP3PR), the entire contents of which are incorporated herein by reference. This application is a continuation in part of U.S. application Ser. No. 11/800,434, filed May 3, 2007 and entitled ELECTROMAGNETIC ENERGY OUTPUT SYSTEM (Att. Docket No. BI9975CIP), and U.S. application Ser. No. 11/800,435, filed May 3, 2007 and entitled TARGET-CLOSE ELECTROMAGNETIC ENERGY EMITTING DEVICE (Att. Docket No. BI9975CIP2), the entire contents of both which are hereby incorporated by reference.

### BACKGROUND OF THE INVENTION

1. Field of the Invention

The present invention relates generally to devices for generating output optical energy distributions and, more particularly, to user interfaces for such devices.

2. Description of Related Art

A variety of electromagnetic energy generating device architectures have existed in the prior art. A solid-state laser system, for example, generally comprises a laser rod for emitting coherent light and a source for stimulating the laser rod to emit the coherent light. The coherent light, which may be referred to as a laser beam, may be delivered to a target surface through a fiber optic waveguide. Care must be exercised to ensure that the laser beam possesses properties appropriate for performance of an intended function. Properties of a laser beam employed in the cutting or removal of, for instance, dental hard tissue may differ from properties of a laser beam employed to coagulate blood in soft tissue. A laser beam may be described by its fluence or power density, which may in turn be measured in, for example, watts per square meter (W/m²), milliwatts per square centimeter (mW/cm²), or the like. Common practice has determined preferred values for fluence or power density levels, depending upon procedures to be performed.

It is important that a user be able to easily, precisely, and accurately control aspects of electromagnetic energy generation including, for example, power level, energy level, pulse duration, and the like.

### SUMMARY OF THE INVENTION

The present invention addresses the need for convenient, precise, and accurate control of electromagnetic energy by providing a method and apparatus for controlling an electromagnetic energy output system. The invention herein disclosed, according to one aspect, provides a laser handpiece adapted to generate electromagnetic energy according to preset parameter values, the preset parameter values being adjustable by using a graphical user interface. A representative embodiment of the graphical user interface comprises a touchscreen disposed on a portable assembly easily held in a hand of a user. The portable assembly may be operably connected with an electromagnetic energy source. A plurality of electromagnetic energy control icons may be displayed on the touchscreen, wherein the electromagnetic energy source is responsive to inputs caused by touching at least one of the electromagnetic energy control icons.

A particular embodiment of the graphical user interface comprises a power level indicator adapted to display a level of power generated by the electromagnetic energy source. For example, the plurality of electromagnetic energy control icons may comprise a power increase icon that controls an increase in the level of power generated by the electromagnetic energy source and a power decrease icon that controls a decrease in the level of generated power.

According to another aspect of the disclosure, the plurality of electromagnetic energy control icons may comprise an energy mode icon, which may control a selection of one of generating electromagnetic energy in a pulsed mode and generating electromagnetic energy in a continuous wave mode.

Yet another aspect of the present invention provides a laser handpiece adapted to independently adjust pulse length and pulse interval of electromagnetic energy generated in the pulse mode, the laser handpiece being operably connected to a computer disposed in a portable assembly easily held in a hand. One embodiment of the computer comprises a processor, working memory, program memory, and a graphical user interface that includes a touchscreen. The embodiment may further include an interface to an electromagnetic energy source adapted to be controlled by the processor and a system bus that communicatively interconnects the processor, working memory, program memory, graphical user interface, and the interface to the electromagnetic energy source. The program memory may have stored therein a power level software module that causes the processor to receive a power level input from the graphical user interface and to communicate with the electromagnetic energy source to control a power level of the electromagnetic energy source according to the power level input.

While the apparatus and method has or will be described for the sake of grammatical fluidity with functional explanations, it is to be expressly understood that the claims, unless expressly formulated under 35 U.S.C. 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. 112 are to be accorded full statutory equivalents under 35 U.S.C. 112.

Any feature or combination of features described herein are included within the scope of the present invention provided that the features included in any such combination are not mutually inconsistent as will be apparent from the context, this specification, and the knowledge of one skilled in the art. For purposes of summarizing the present invention, certain aspects, advantages and novel features of the present invention are described herein. Of course, it is to be understood that not necessarily all such aspects, advantages or features will be embodied in any particular embodiment of the present invention. Additional advantages and aspects of the present invention are apparent in the following detailed description and claims that follow.

### BRIEF DESCRIPTION OF THE FIGURES

FIGS. 1-9 are two-dimensional representations of implementations of touchscreen displays in a graphical user interface suitable for controlling an electromagnetic energy output system;

FIGS. 9A-9G are two-dimensional representations of implementations of touchscreen displays for facilitating modification of preset values of parameters that control an electromagnetic energy output system;

FIGS. 10-12 are two-dimensional representations of implementations of touchscreen displays of a graphical user interface for controlling an electromagnetic energy output system;

FIG. 13 is a block diagram of an embodiment of a computer system adapted to implement the touchscreen displays of FIGS. 1-12; and

FIG. 14 is a flow diagram illustrating one implementation of a method of controlling an electromagnetic energy output system.

### DETAILED DESCRIPTION OF THE INVENTION

Reference will now be made in detail to embodiments of the invention, examples of which are illustrated in the accompanying drawings. Wherever possible, the same or similar reference numbers are used in the drawings and the description to refer to the same or like parts. It should be noted that the drawings are in simplified form and are not to precise scale. In reference to the disclosure herein, for purposes of convenience and clarity only, directional terms, such as, top, bottom, left, right, up, down, over, above, below, beneath, rear, and front, are used with respect to the accompanying drawings. Such directional terms should not be construed to limit the scope of the invention in any manner.

Although the disclosure herein refers to certain illustrated embodiments, it is to be understood that these embodiments are presented by way of example and not by way of limitation. The intent of this disclosure, while discussing exemplary embodiments, is that the following detailed description be construed to cover all modifications, alternatives, and equivalents of the embodiments as may fall within the spirit and scope of the invention as defined by the appended claims. It is to be understood and appreciated that the process steps and structures described herein do not cover a complete process flow for the control of electromagnetic energy output systems. The present invention may be practiced in conjunction with various computer, display, and laser control techniques that are conventionally used in the art, and only so much of the commonly practiced process steps are included herein as are necessary to provide an understanding of the present invention. The present invention has applicability in the field of electromagnetic energy generating devices in general. For illustrative purposes, however, the following description pertains to a method and apparatus for controlling a hand-held medical laser.

The above-referenced U.S. application Ser. Nos. 11/800,434 and 11/800,435 (the '43x applications) disclose electromagnetic energy output devices (e.g., a lasers) for implementing surgical, (e.g., dental) procedures on hard or soft tissue. The electromagnetic energy output devices disclosed therein can be configured, for example, to be particularly suited for soft tissue cutting or for ablating procedures. Other applications of the electromagnetic energy output devices can include decontamination, cleaning periodontal pockets, pain reduction, and biostimulation procedures.

Configuring one of the electromagnetic energy output devices for the above-listed and other applications can require that methods and apparatus be provided to control properties of the electromagnetic energy generated by the device. The devices disclosed in the '43x applications can employ, according to an aspect of the invention, graphical user interfaces implemented on a portable assembly capable of being held in a human hand. One possible implementation of such a device is illustrated in a perspective view of FIG. 26A of the '43x applications showing a possible implementation of a graphical user interface in the form of a touchscreen 156. The illustrated assembly may be operatively configured with an electromagnetic energy source as described in the '43x applications. The embodiment illustrated in FIG. 26A of the '43x applications further includes user-interface inputs comprising an ENTER input and four arrow inputs at the bottom of the device. The depicted assembly can be mounted, for example, to a wrist or wall (e.g., with a battery, with fewer hard or physical buttons and more of a display/software driven user interface, and shorter cables/fibers) as exemplified in FIGS. 15 and 18, respectively, of the '43x applications and as elucidated in the discussions pertaining to those figures.

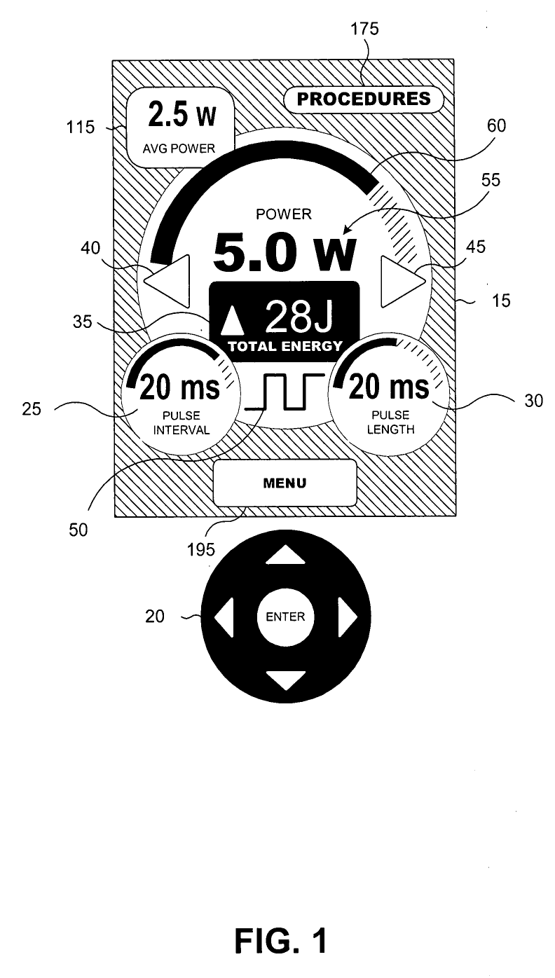

A two-dimensional representation of a portion of an embodiment of a graphical user interface of a type illustrated in FIG. 26A of the '43x applications is illustrated in FIG. 1. The illustrated embodiment includes a touchscreen 15 as well as a control wheel 20 (described infra) having an ENTER input with four arrow inputs. The illustrated interface displays values for and may enable control of several parameters of an electromagnetic energy source adapted to perform, for example, surgical procedures as described in the '43x application. The illustrated interface includes a plurality of electromagnetic energy control icons 25, 30, 35, 40, 45, and 50, for example, which are explained individually in the sequel which follows.

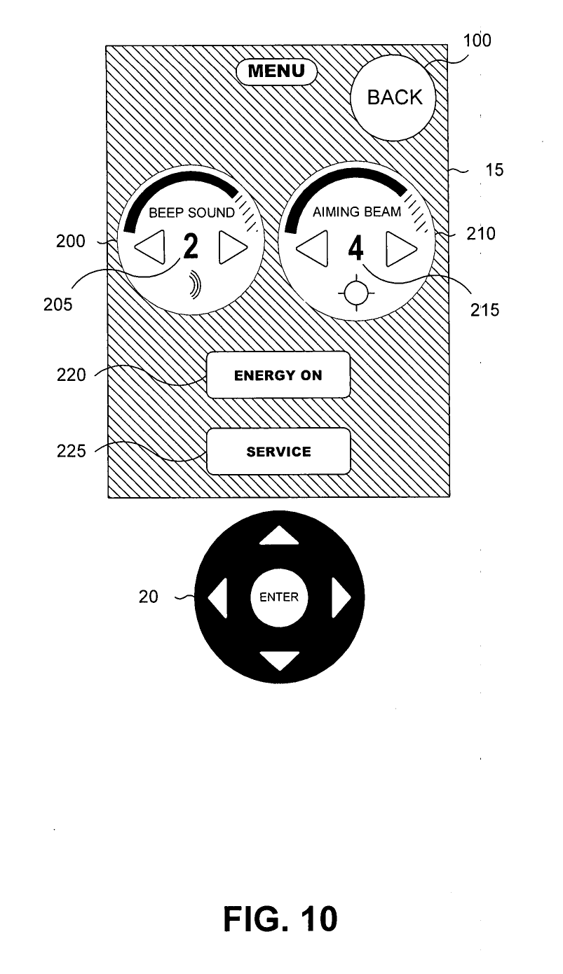

The graphical user interface of FIG. 1 further includes a power level indicator 55 adapted to display a level of power generated by the electromagnetic energy source. The level of power may be controlled by pressing (e.g., touching) a power decrease icon 40 in order to decrease the level of power generated by the electromagnetic energy source (and consequently, decrease the value of the power level displayed by the power level indicator 55). Similarly, the level of power may be increased by touching a power increase icon 45. The illustrated embodiment further includes a simulated analog representation 60 (as, for example, with a thermometer, speedometer and the like) of the power level relative to a maximum possible power level setting. Similar simulated analog representations appear, for example, in a pulse interval icon 25 and a pulse length icon 30, which icons are described infra. Icons 200 and 210 described infra relative to FIG. 10 include similar simulated analog representations.

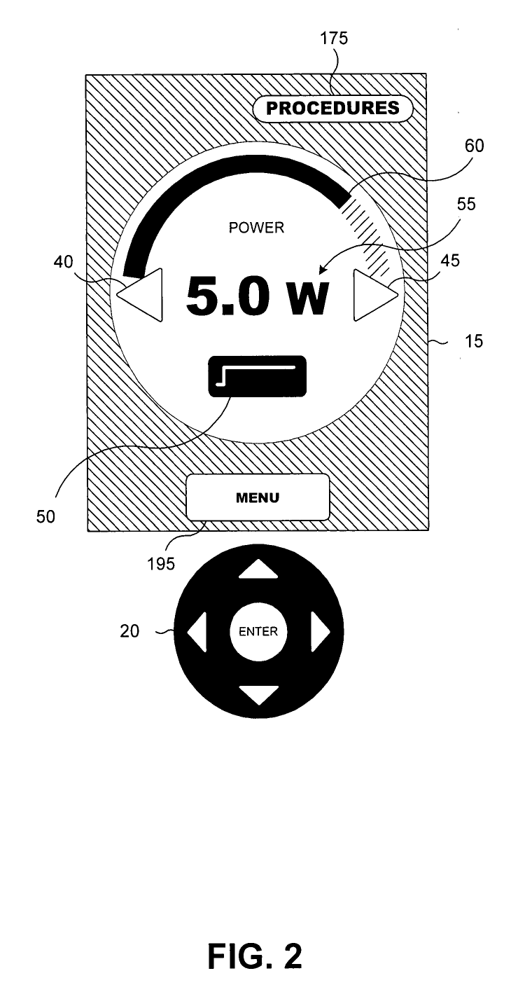

The illustrated graphical user interface further includes an energy mode icon 50, which both indicates and controls a mode of electromagnetic energy generation of the electromagnetic energy source. The energy mode icon 50 can be activated or “pressed” by (1) “selecting” it using the control wheel so that the icon is highlighted, e.g., by enhancing its border, and then “entering” that selection by pressing the ENTER button of the control wheel, or by (2) touching or clicking on the energy mode icon 50 using a finger or stylus. Upon activation, the energy mode may change from a pulsed energy mode corresponding to the graphical display shown in FIG. 1 to a continuous wave mode corresponding to a graphical display as shown in FIG. 2 wherein a form of the energy mode icon 50 changes to a continuous wave graphic, e.g., a blank or darkened area with a single square wave ramp-up followed by a steady-state value.

Pressing the energy mode icon 50 of FIG. 2 switches (e.g., toggles) back to the pulsed energy mode, and the graphical display again appears as shown in FIG. 1. As can be inferred from the terminology, the electromagnetic energy source may generate electromagnetic energy continuously when in the continuous wave mode and may generate energy in a form of pulses when in the pulsed energy mode.

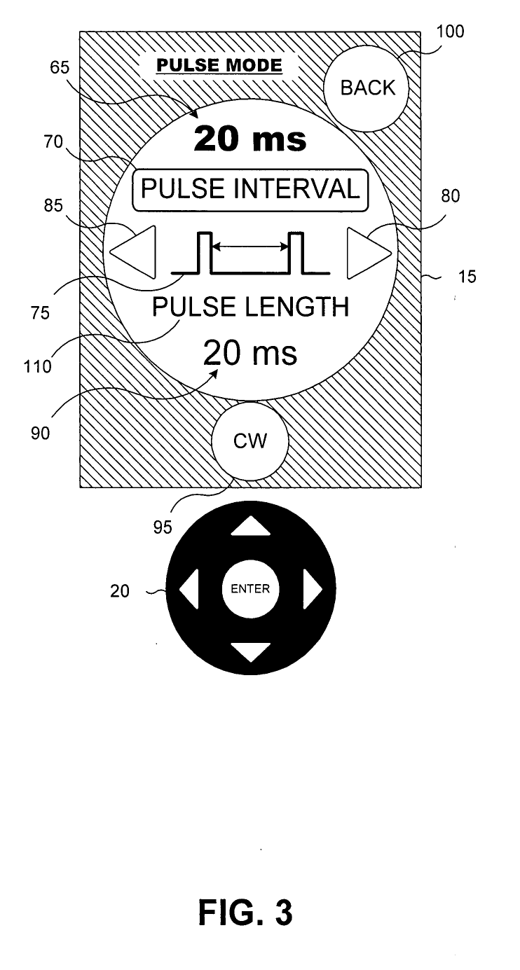

One implementation of the graphical user interface of FIG. 1, which may be used to control, for example, a laser handpiece, includes a pulse interval icon 25 and a pulse length icon 30. Selecting the pulse interval icon 25, according to the illustrated implementation, may highlight the pulse interval icon 25 (e.g., by enhancing its border). Subsequently, pressing ENTER with the highlighted pulse interval icon 25 selected may change the appearance of the graphical display to a screen as illustrated in FIG. 3, which includes an emphasized (e.g., bold, different color, or the like) value (e.g., 20 ms) for a pulse interval, the words “PULSE INTERVAL” 70 highlighted (e.g., outlined, different color, etc.) and a pulse interval graphic 75. A pulse interval increase icon 80 and a pulse interval decrease icon 85 are further included, which, when pressed, may, respectively, lengthen or shorten a time duration between pulses (i.e., an “OFF” time) of electromagnetic energy generated by the electromagnetic energy source. To store a value for pulse interval, the pulse interval increase/decrease icons 80/85 may be used and then the PULSE INTERVAL icon 70 may be pressed, which brings up the display of FIG. 1 with the pulse interval icon 25 displaying a (possibly) modified value.

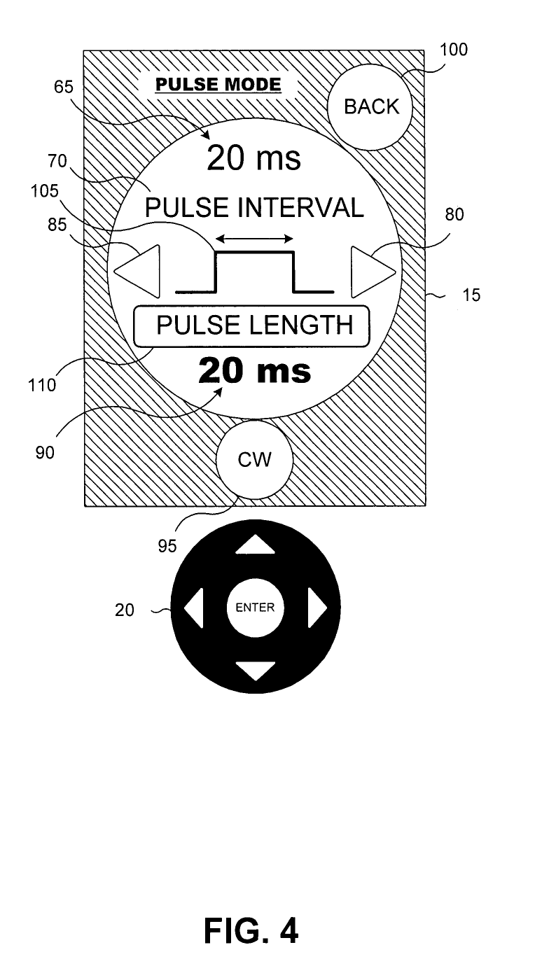

The illustrated screen of FIG. 3 further includes an indication of a pulse length 90, 110 (described more fully infra with reference to FIG. 4) and a “CW” icon 95, which when pressed may switch the electromagnetic energy source into a continuous wave mode and may change the display to the one shown in FIG. 2, thereby providing an alternative method of reaching the screen of FIG. 2. The implementation of FIG. 3 further includes a BACK icon 100, which, when pressed, may return the display to that shown in FIG. 1 without registering any changes made while in the screen of FIG. 3. In a modified embodiment, pressing the BACK icon 100 may register any changes made while in the screen of FIG. 3 and return the display to that shown in FIG. 1.

Returning to FIG. 1, selecting the pulse length icon 30 may highlight the pulse length icon 30 (e.g., by enhancing its border). Pressing ENTER with the highlighted pulse length icon selected may then change the graphical display to that illustrated in FIG. 4. Regarding the FIG. 4 display, it includes, in a manner analogous to the description of FIG. 3, a pulse length graphic 105, the words “PULSE LENGTH” 110 highlighted, and a value for pulse length 90 emphasized. Icons 85 and 80 change function in FIG. 4 from their roles in FIG. 3 and now may be used to adjust the length of pulses of electromagnetic energy generated by the electromagnetic energy source. Icons 85 and 80, therefore, function, respectively, as pulse length increase and pulse length decrease icons on the screen of FIG. 4. Adjusting the pulse length using icons 85/80 and then pressing the PULSE LENGTH icon 110 stores a new value for pulse length and returns the display to that of FIG. 1. As was the case for FIG. 3, pressing CW 95 in FIG. 4 may switch the electromagnetic energy source to the continuous wave mode and may cause the screen shown in FIG. 2 to be displayed. Pressing BACK 100 in FIG. 4 can return the display to that shown in FIG. 1 without registering any changes made while in the screen of FIG. 4.

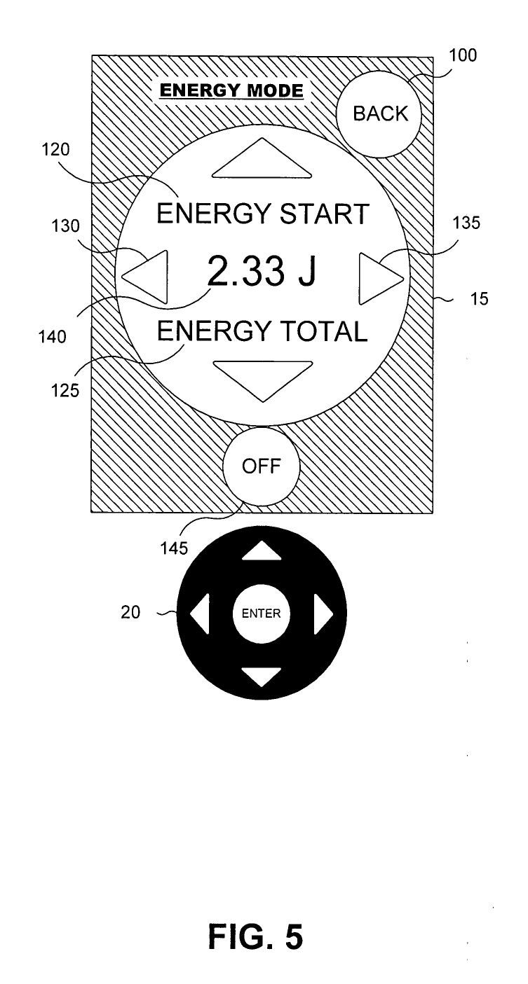

Returning again to FIG. 1, the illustrated embodiment further includes an average power indicator 115 that may display an average power level according to the power level of the electromagnetic energy source (shown by the power level indicator 55), the pulse interval (shown in the pulse interval icon 25) and the pulse length (shown in the pulse length icon 30). The implementation shown in FIG. 1 further includes a total energy level icon 35, which, in the indicated implementation, may function as both a total energy level indicator and as an electromagnetic energy control icon. As a total energy level indicator, the total energy level icon 35 may display (depending upon context as described infra with reference to FIG. 5) an amount of electromagnetic energy already generated or an amount of electromagnetic energy to be delivered by the electromagnetic energy source. As an electromagnetic energy control icon, the total energy level icon 35, when selected, may be highlighted; where after pressing ENTER with the highlighted energy level icon 35 selected may switch the graphical user interface to a screen as shown in FIG. 5.

The screen of FIG. 5 facilitates controlling energy delivered or to be delivered by the electromagnetic energy source. The screen comprises an ENERGY START icon 120, which, when pressed, enables calculation of electromagnetic energy delivered (e.g., to tissue). The screen of FIG. 5 further comprises an ENERGY TOTAL icon 125, an energy decrease icon 130, and an energy increase icon 135. The total energy delivered or to be delivered may be displayed, according to the illustrated embodiment, with an energy indicator 140; an initial value of energy displayed by the energy indicator 140 can be adjusted downward by pressing the energy decrease icon 130 or adjusted upward by pressing the energy increase icon 135. (In an exemplary mode of operation, the value displayed in the energy indicator 140 is adjusted to zero when the ENERGY START icon 120 is pressed.) Pressing the ENERGY TOTAL icon 125 may set a total amount of energy to be delivered by the electromagnetic energy source. For example, to deliver a total of 5 joules (watt-seconds) of energy, the value displayed by the energy indicator 140 may be adjusted to 5.00 using the energy decrease 130 and energy increase 135 icons and then pressing the ENERGY TOTAL 125, or visa versa.

According to one operating mode, inputs presented to the touchscreen are accepted as parameter values for the electromagnetic energy source. The electromagnetic energy source may be turned on/off using a foot pedal or switch (not shown). When turned on by the foot switch, the electromagnetic energy source may generate energy according to the parameter values. For example, the electromagnetic energy source may deliver the set amount of energy represented by the ENERGY TOTAL icon 125 (either continuously with the foot switch turned on continuously or cumulatively in bursts if the foot switch is turned on and off) and then cease to deliver energy. For example, at a power level of 0.5 watts, the electromagnetic energy source would operate for a total of 10 seconds to deliver 5 joules of energy while the foot switch is on. It should be understood that the foot switch may be turned on for, as an example, five separated two-second periods for the total electromagnetic energy delivered to reach 5 joules. Pressing either ENERGY START 120 or ENERGY TOTAL 125 may cause a return to the screen of FIG. 1 with a (possibly) new value for total energy shown by the total energy indicator 35.

The illustrated screen of FIG. 5 further comprises an OFF icon 145, which, when pressed, may turn off the electromagnetic energy source.

A non-touchscreen operating mode for the screens described above relative to FIGS. 1-5 comprises using the control wheel 20 illustrated, for example, in FIG. 1. According to this operating mode, one of the plurality of electromagnetic energy control icons in, for example, FIG. 1 may be highlighted. Pressing an up or down arrow of the control wheel 20 may control which icon is highlighted. When an icon is highlighted, pressing ENTER on the control wheel 20 is equivalent to pressing the icon (highlighted or not) on the touchscreen. In FIGS. 3 and 4, pressing the up/down arrows on the control wheel 20 may cause, successively, the PULSE INTERVAL 70, PULSE LENGTH 110, and CW 95 icons to be highlighted (e.g., shown with a yellow background). Pressing the left/right arrows on the control wheel may adjust highlighted numerical values on the touchscreen, and pressing ENTER may store the new values and return to the screen of FIG. 1. Similarly, in FIG. 5, pressing the up/down arrows on the control wheel 20 may cause the ENERGY START 120, ENERGY TOTAL 125, and OFF 145 icons to be successively highlighted. Pressing the left/right icons on the control wheel 20 may decrease/increase a numerical value associated with a highlighted icon, and pressing ENTER may store the numerical value and return the display to that of FIG. 1.

The preceding description describes a portion of possible transitions among screens of the forms shown in FIGS. 1-5. Other configurations and/or sequences are possible as will readily occur to one skilled in the art. These other configurations and/or sequences are contemplated by the present disclosure.

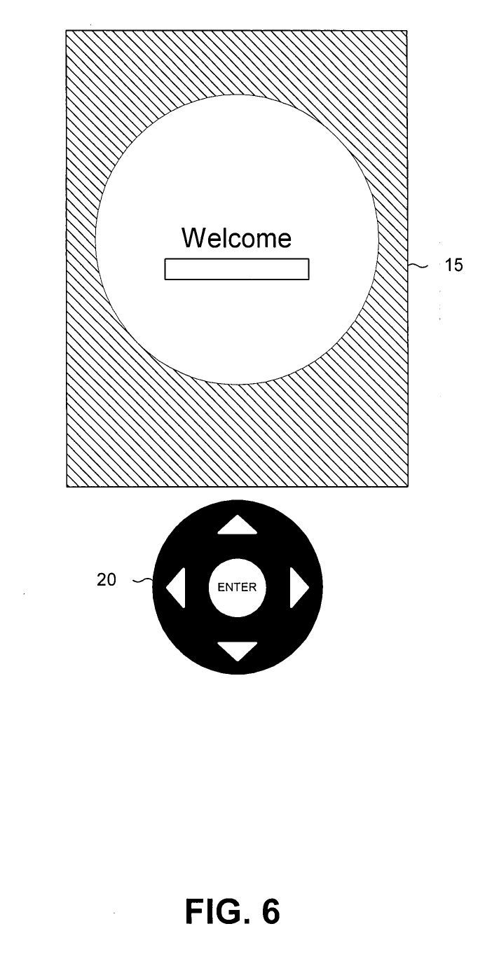

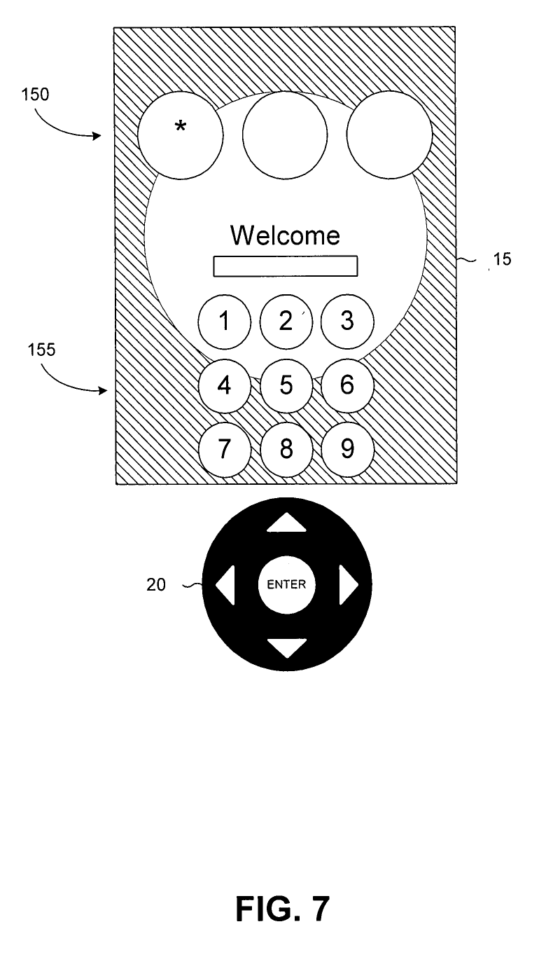

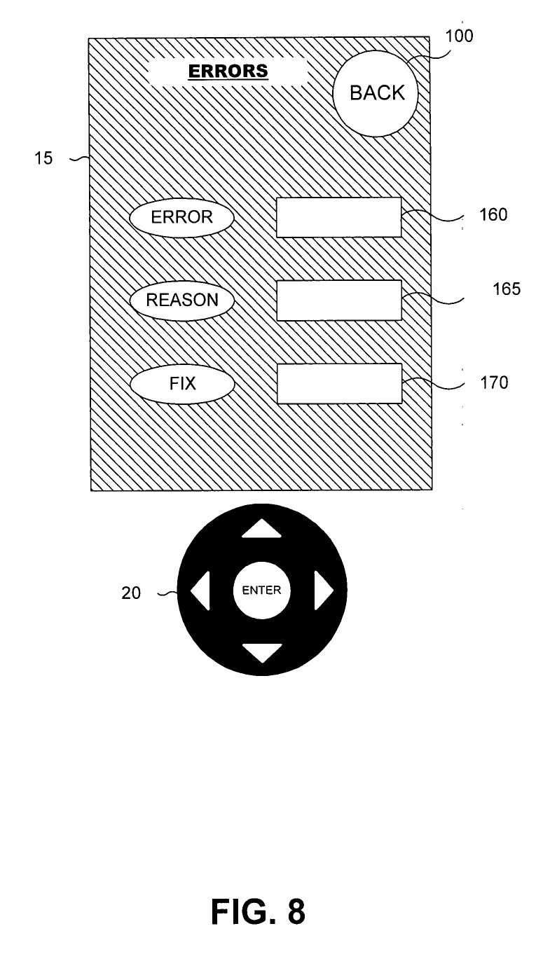

Additional screens in the graphical user interface may provide additional support functions that may be helpful to a user. For example, on power-up, a first welcome screen may be displayed as shown in FIG. 6. In accordance with a representative embodiment, the first welcome screen of FIG. 6 automatically transitions after a few seconds to a second welcome screen as illustrated in FIG. 7. The second welcome screen may comprise a plurality of fields 150 (three are shown in FIG. 7) wherein a user may be invited to enter an access code using, for example, a keypad 155 either in a touchscreen mode or by using the control wheel 20 to select each digit from the keypad and then pressing ENTER to place that digit in one of the fields 150. When a valid access code is entered, the screen may transition to that shown in FIG. 1, and a user may commence normal operation. If an invalid access code is entered, then an error screen, an example of which is illustrated in FIG. 8, may be displayed. According to the illustrated embodiment, a field 160 on the error screen may identify an error, and a field 165 may provide a brief explanation of the error, with another field 170 explaining how the error may be fixed. The BACK icon 100 may enable a user to restart from the second welcome screen (FIG. 7).

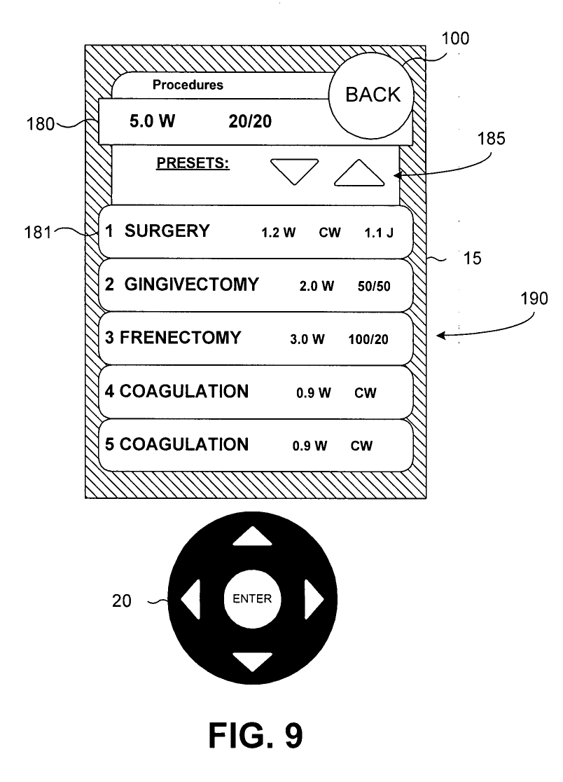

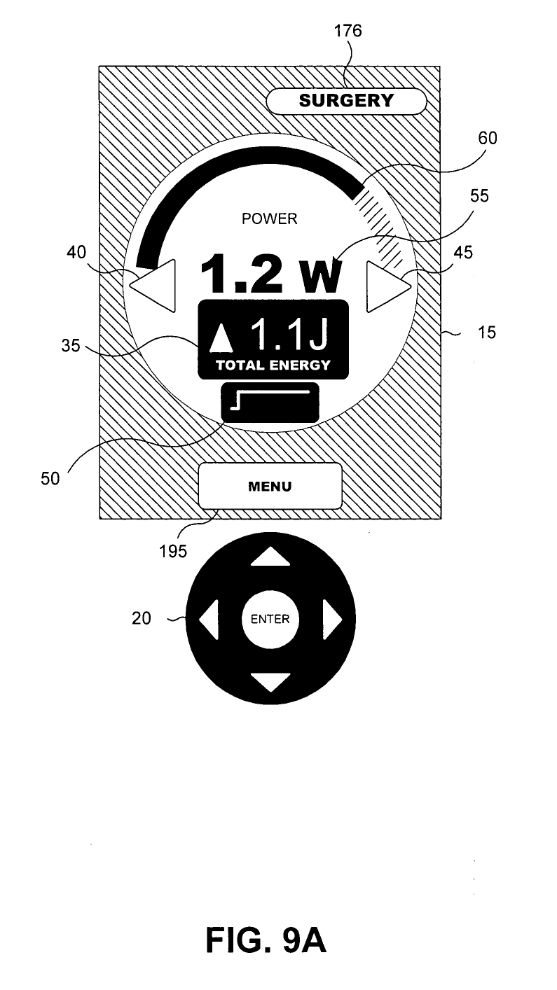

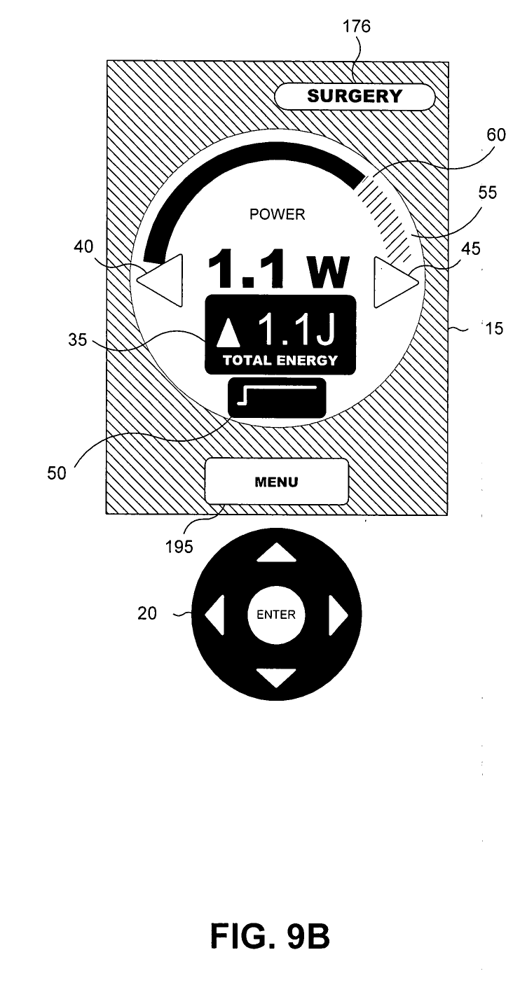

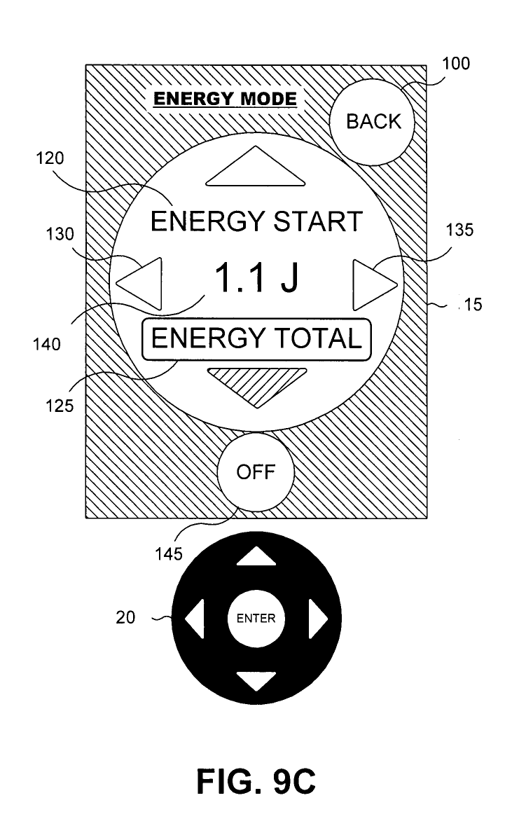

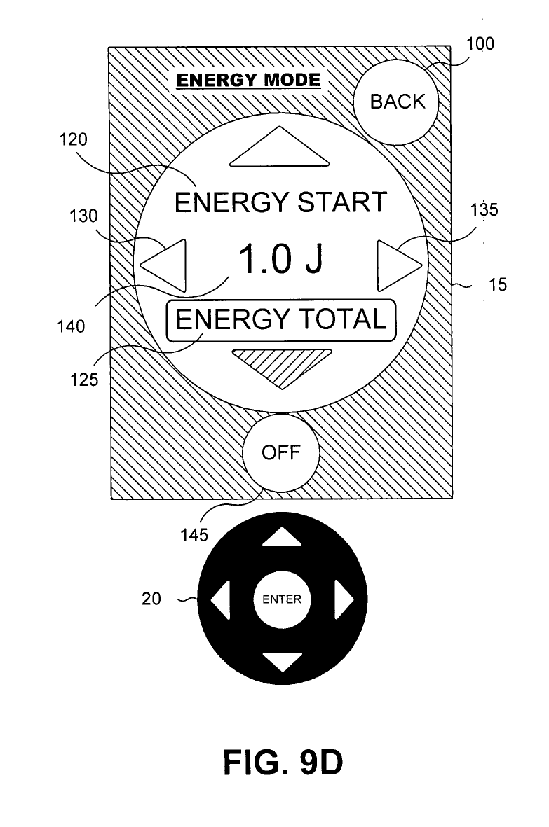

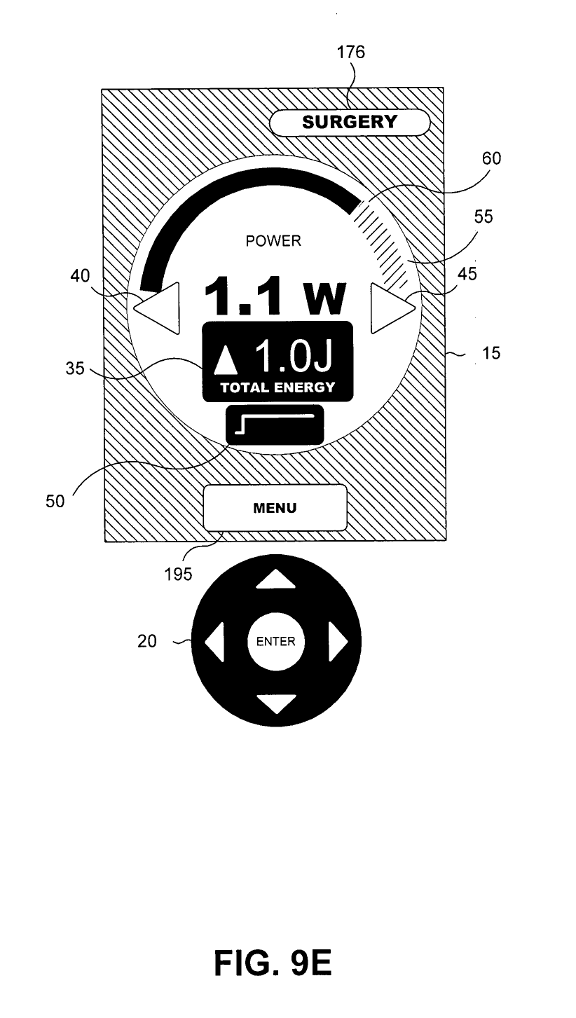

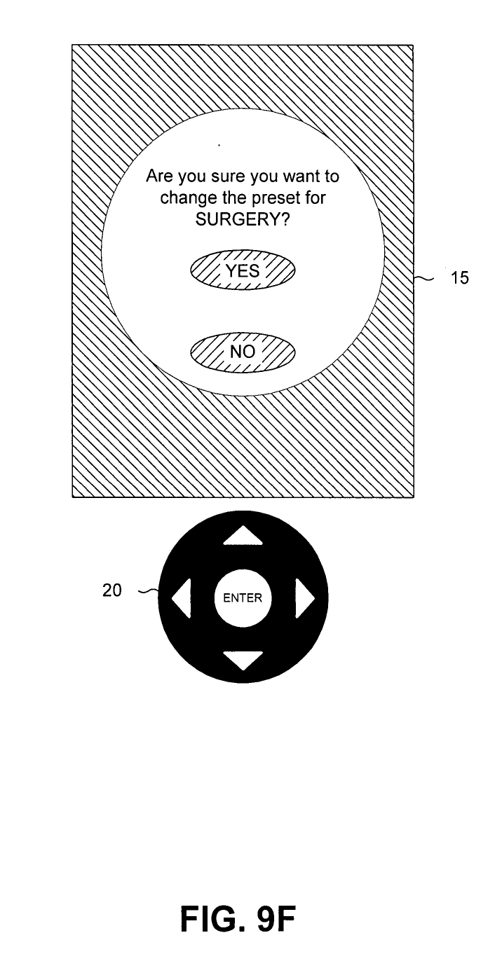

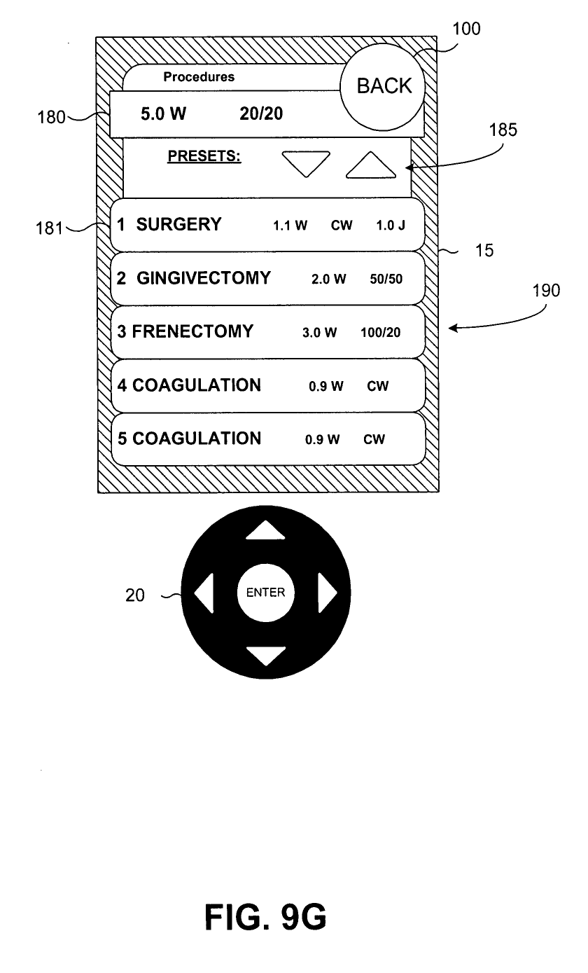

The screen of FIG. 1 (and, as another example, FIG. 2) comprises a PROCEDURES icon 175, which when pressed, may bring up a procedures screen, an example of which is shown in FIG. 9. The procedures screen of FIG. 9 contains a field 180 displaying current settings of the electromagnetic energy output device. In the illustrated example, the device is set at a power level of 5.0 W in a pulse mode with 20 ms pulse length and a 20 ms pulse interval.

An embodiment of the procedures screen further comprises a PRESETS field having up/down arrows 185 that may cause a scrollable list of procedure icons 190 to be scrolled, up or down. Each of several presets may comprise a particular combination of values for each of several parameters for controlling the electromagnetic energy output system according to a particular procedure. Parameters may include power level, total energy level, energy mode, pulse length, and pulse interval, among others. Pressing one of the procedure icons may adjust or “preset” the electromagnetic energy output device according to settings listed on that procedure icon. For example, pressing (i.e., touching) a SURGERY icon 181 in FIG. 9 may set the electromagnetic energy output device to a power level of 1.2 watts in a continuous wave mode with a total energy to be delivered of 1.1 joules.

According to another embodiment, pressing (i.e., selecting) a procedure icon on the procedures screen twice in rapid succession [or prefacing a single pressing with a pressing of, for example, a MODIFY icon (not shown)] may return the user to a screen having a modified form of FIG. 1 (if the selected procedure employs the pulse mode) or FIG. 3 (if the selected procedure employs the continuous wave mode) wherein a user may adjust values of preset parameters. For example, pressing the SURGERY icon 181 may display the screen shown in FIG. 9A, the form of which can be likened to that of FIG. 3, wherein the BACK icon 100 of FIG. 3 is replaced by a procedure identifier 176 (i.e., SURGERY in the present example). In accordance with the parameter values displayed in the SURGERY icon 181 of FIG. 9, the power level indicator 55 in FIG. 9A displays a power level of 1.2 W, the energy mode icon 50 indicates a continuous wave mode of electromagnetic energy generation, and the total energy to be delivered, as indicated by the total energy level icon 35, is 1.1 joules. If a user, on a basis for example of personal preference or experience, wishes to change parameter values for one or more of the presets given in FIG. 9, a natural and convenient capability for such a change may be provided on the screen of FIG. 9A. A user may, for example, use the power increase/decrease 45/40 icons to adjust the power level. As shown in FIG. 9B, the user may adjust the power level to 1.1 W as indicated by the power level indicator 55.

As a further example, the user may wish to reduce the total energy delivered from 1.1 joules to, say, 1.0 joule. As will be readily appreciated by the user, according to an aspect of the invention, an intuitive and natural way of making such a change comprises pressing the total energy level icon 35 when, for example, the screen of FIG. 9B is displayed. Pressing the total energy level icon 35 may bring up a screen similar to that of FIG. 5, but with the ENERGY TOTAL icon 125 highlighted as shown in FIG. 9C. Using the energy increase/decrease icons 135/130, the user may adjust the total energy, for example, to 1.0 joules as shown in FIG. 9D. Pressing the ENERGY TOTAL icon 125 then may return the user to the display of FIG. 9B, but with the value of total energy now modified to 1.0 joules as shown in FIG. 9E. Pressing the procedure identifier 176 (displaying, for example, SURGERY in FIGS. 9A, 9B, and 9E), may return the user to a display of the procedures menu of FIG. 9, but with modified values according to changes made as just described. As a safety measure, an intermediate “Are you sure . . . ?” screen similar to that shown in FIG. 9F may be displayed. If a user selects YES on the screen, then the modified procedures screen may be displayed as shown in FIG. 9G. If the user selects NO, then any modifications may be lost, and the user returned to the procedures screen (FIG. 9) without any changes.

A plurality (which may total, e.g., 15) of presets may be included, the presets relating to, in addition to surgery, coagulation and, in other examples, dental procedures for gingivectomy, troughing, curettage, excision, frenectomy, and the like. Custom presets may also be provided that may be conveniently and intuitively configured by a user in a manner similar to the modification of the SURGERY presets as described supra. According to yet another operating mode, a user may adjust values of parameters for a procedure on a main menu (on, for example, a screen similar to that shown in FIG. 1), by selecting the PROCEDURES mode (by, for example, pressing the PROCEDURES icon in FIG. 1) and then pressing and holding an icon corresponding to a name of the procedure for 2 seconds to change and store new parameters for the procedure.

Some screens of the graphical user interface (e.g., FIGS. 1 and 2) are constructed to include a MENU icon 195. Pressing the MENU icon 195 may bring up a screen as shown in FIG. 10 that includes icons for enabling control of other aspects of an electromagnetic energy output system. For example, the screen may include, as shown, a BEEP SOUND icon 200 including a beep sound indicator 205 that displays a beep sound level, which level may be increased or decreased by operation of increase/decrease icons displayed as part of the icon. The beep sound may be heard when, for example, a user presses an icon on the graphical user interface described herein with reference to FIGS. 1-12. Similarly, an AIMING BEAM icon 210 may be included, the AIMING BEAM icon 210 including an aiming beam indicator 215 indicative of an intensity or brightness level of an aiming beam, which may be used in some applications to illuminate an area of, for example, tissue to be treated by a laser beam produced by the electromagnetic energy output system. The brightness level may be adjusted up or down by way of increase/decrease icons included as part of the AIMING BEAM icon 210.

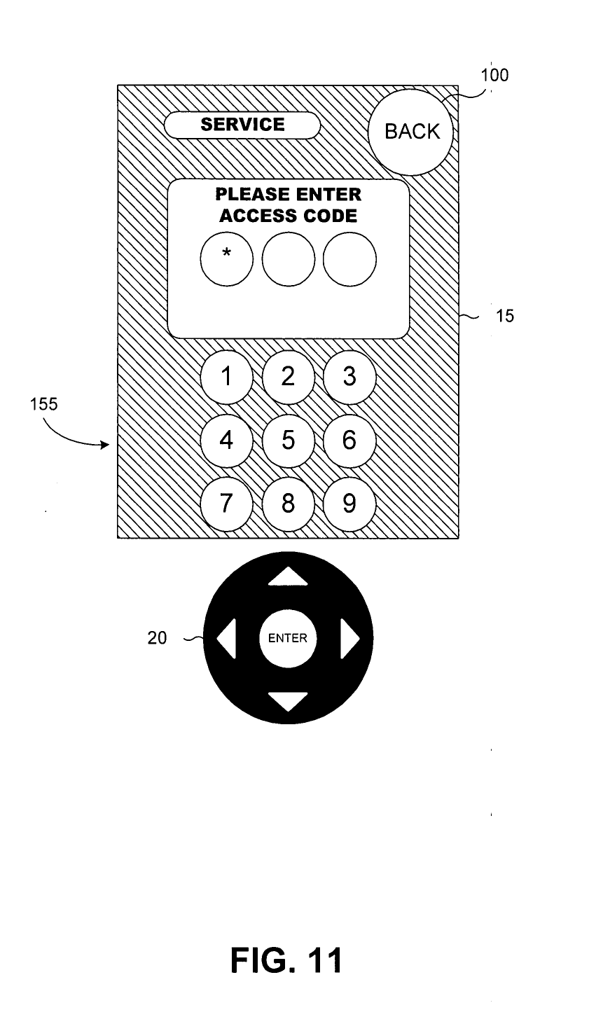

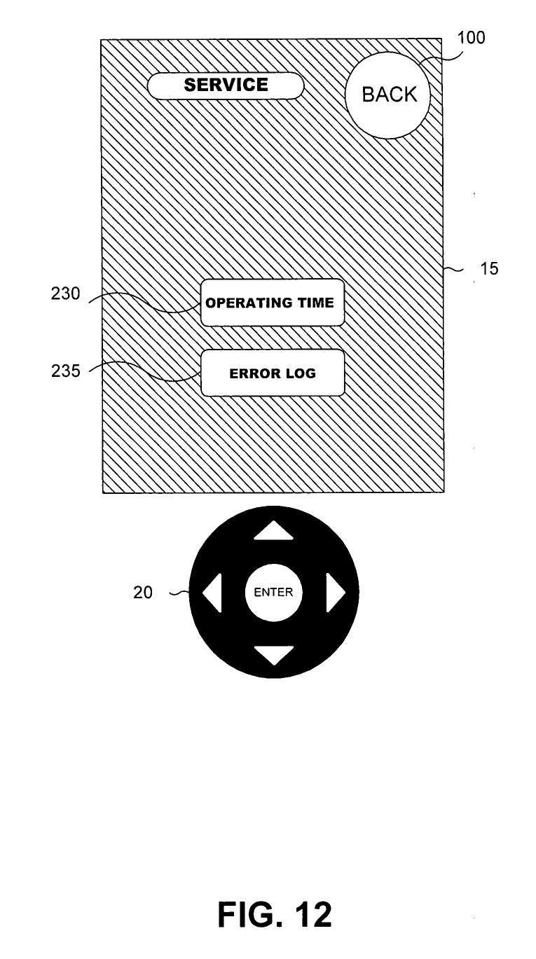

The screen of FIG. 10 may further comprise an ENERGY ON icon 220, which, when pressed, may turn on the electromagnetic energy source after storing and activating any changes made in, for example, beep sound or aiming beam brightness and which, in accord with one embodiment, may bring up the screen of FIG. 1. The screen of FIG. 10 still further may comprise a SERVICE icon 225, which, when pressed, may bring up a service screen, an example of which is illustrated in FIG. 11. The service screen of FIG. 11 may include a facility for entering an access code (cf. FIG. 7). If a valid access code is entered, then a user may be presented with a screen similar to that shown in FIG. 12, which may permit the user to select, for example, a display of operating time or an error log, reachable by pressing, for example, an OPERATING TIME icon 230 or an ERROR LOG icon 235.

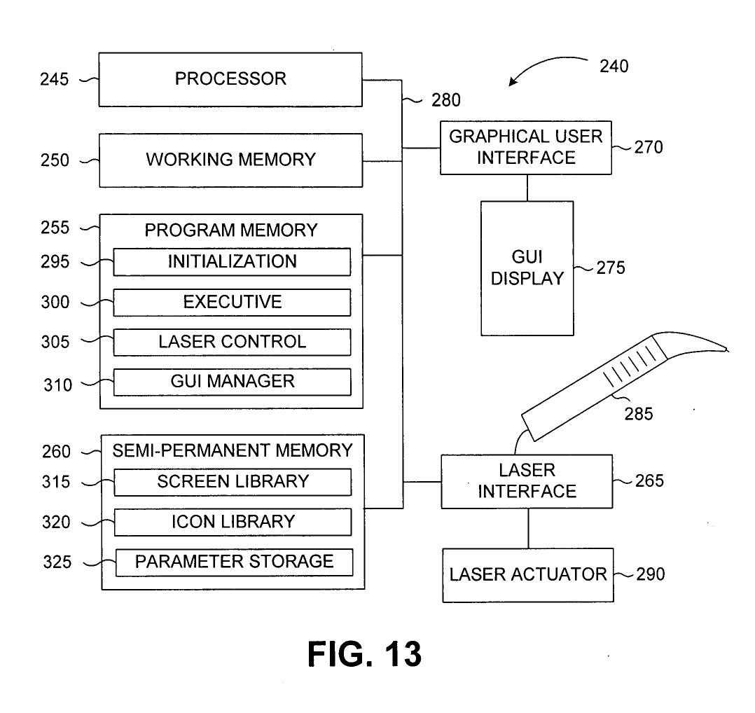

An embodiment of a computer system 240 that may be adapted to independently adjust pulse length and pulse interval of electromagnetic energy generated in a pulse mode by a laser handpiece is illustrated in FIG. 13. The embodiment depicted in FIG. 13 may include the graphical user interface (GUI) 270 described supra with reference to FIGS. 1-12. The illustrated embodiment, which may be disposed in a portable assembly easily held in a hand as illustrated, for example, in FIG. 20B of the '43x applications, comprises a processor 245, working memory 250, which may be random-access memory, program memory 255, semi-permanent memory 260, which may be flash memory in some embodiments, a laser interface 265, and a graphical user interface 270. A system bus 280 may communicatively interconnect the aforementioned elements. The illustrated embodiment further includes a GUI display 275 responsive to signals received from the graphical user interface 270. The GUI display 275 may be of a touchscreen type in some embodiments adapted to receive user input in a form of touches to icons on the GUI display 275. Typical embodiments include an electromagnetic energy output device such as a laser handpiece 285 and further include, for example, a laser actuator 290. The laser actuator 290 may take a form of, according to one embodiment, a foot-operated switch that interacts with the laser interface 265 in accordance with signals received from the processor 245 in order to control the electromagnetic energy output device.

The program memory 255 of the illustrated computer system 240 may have stored therein software modules that, when executed, may cause the processor 245 to perform certain functions according to the software modules. For example, software modules comprising an initialization module 295, an executive module 300, a laser control module 305, and a graphical user interface manager 310 maybe included. Additionally, the semi-permanent memory may store such items as a screen library 315 and an icon library 320 and, further, may include locations identified in FIG. 13 as parameter storage 325 for storing system parameters.

According to one exemplary mode of operation, the processor 245 in the computer system 240 may, upon power-up, execute the initialization module 295, which may cause the processor 245 to perform certain initialization tasks such as recalling parameter values from parameter storage 325, which parameters may determine settings for an electromagnetic energy source such as the laser handpiece 285 (e.g., power level, pulse length, etc.). The processor 245, further, may communicate with the GUI manager 310, which may cause the processor 245 to retrieve a welcome screen from the screen library 315 and to present the welcome screen on the GUI display 275 (cf. FIG. 6). The processor 245 may then execute the executive software module 300, which may cause the processor 245 to execute the GUI manager module 310. The GUI manager 310 may cause the processor 245 to retrieve from the screen library 315 and to display a modified welcome screen such as that shown, for example, in FIG. 7, which may invite a user to enter an access code into the GUI display 275. If an invalid access code is received by the processor 245, then the GUI manager 310 may cause the processor 245 to display on the GUI display 275 an error screen, an example of which is illustrated in FIG. 8. Upon receiving a valid access code, the GUI manager 310 may cause the processor 245 to retrieve from the screen library 315 and to display on the GUI display a main screen of a form illustrated, for example, in FIG. 1. Details of the display may be influenced by values of parameters found in parameter storage 325, which values may be used by the processor 245 to modify icons retrieved from the icon library 320 and used to populate the main screen.

Thereafter, the computer system 240 of FIG. 13 may perform functions relative to the GUI display 275 as described supra with reference to FIGS. 1-12 in a manner that will be apparent to one skilled in the art.

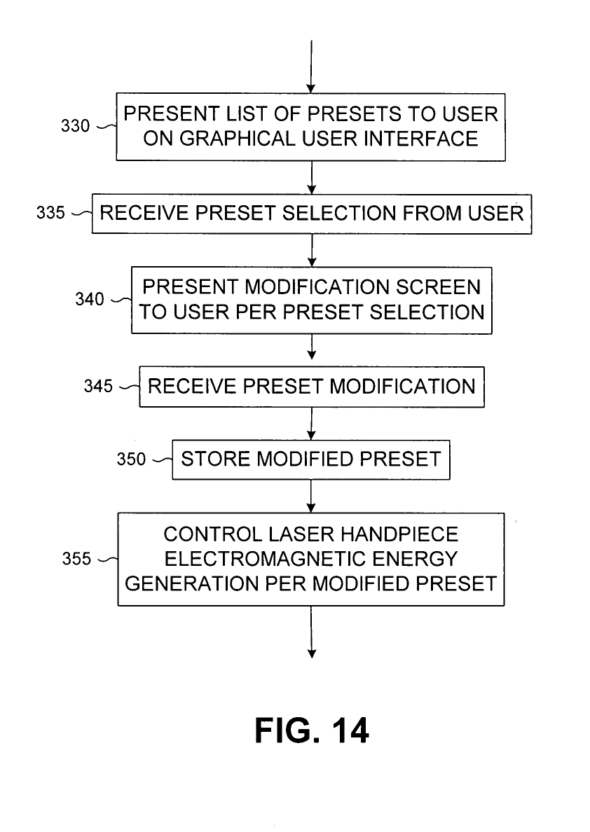

FIG. 14 is a flow diagram illustrating one implementation of a method of controlling an electromagnetic energy output system according to an implementation of the present invention. The illustrated example comprises presenting presets to a user on a graphical interface at step 330. The graphical interface may present, at step 330, a screen comprising a scrollable list of procedure icons 190 similar to, for example, the screen illustrated in FIG. 9, wherein procedure icons 190 are identified by a name for each procedure and which screen, further, may display a summary of parameter values associated with the procedure. According to one exemplary embodiment, a user may adapt one or more operational settings of the electromagnetic energy output system according to unique criteria such as personal preference or experience, in a convenient and intuitive manner, thereby enhancing versatility of the electromagnetic energy output system. As such, the graphical user interface may provide for a quick, convenient, and easy means to modify operating modes of the electromagnetic energy output system.

User input may be received at step 335 in a form, according to a typical embodiment, of a touch to a screen of a graphical user interface, the screen presenting a display of a form of, for example, FIG. 9, by which touch the user selects a preset from the scrollable list of procedure icons 190. A modification screen may be presented at step 340 according to the selected preset. For example, a screen similar to that shown in FIG. 9A may be presented, wherein a user is able to adjust (i.e., modify) preset power and total energy settings in a manner described supra in connection with the discussion of FIGS. 9A-9G. Modifications to the preset values may be received at step 345 according to user inputs as likewise described supra in connection with the discussion of FIGS. 9A-9G, and the modified preset may be stored at step 350 as described above with regard to FIGS. 9E-9G. The electromagnetic energy source (e.g., a laser handpiece) thereafter may be controlled at step 355 according to the modified preset.

In view of the foregoing, it will be understood by those skilled in the art that the methods and apparatuses of the present invention can facilitate rapid, intuitive, accurate and efficient control of an electromagnetic energy output system. The above-described embodiments have been provided by way of example, and the present invention is not limited to these examples. Multiple variations and modification to the disclosed embodiments will occur, to the extent not mutually exclusive, to those skilled in the art upon consideration of the foregoing description. Additionally, other combinations, omissions, substitutions and modifications will be apparent to the skilled artisan in view of the disclosure herein. Accordingly, the present invention is not intended to be limited by the disclosed embodiments, but is to be defined by reference to the appended claims.

1. A laser handpiece device adapted to generate electromagnetic energy according to a plurality of preset parameter-value combinations, the device comprising:
a graphical user interface adapted to present the plurality of preset parameter-value combinations to a user, the graphical user interface being further adapted to receive adjustment to a selected one of the plurality of preset parameter-value combinations and to store the adjusted parameter-value combination for future selection;
a touchscreen disposed on a portable assembly easily held in a hand, the portable assembly being operably connected with an electromagnetic energy source; and
a plurality of electromagnetic energy control icons displayed on the touchscreen, wherein the electromagnetic energy source is responsive to inputs caused by touching at least one of the electromagnetic energy control icons.

2. The laser handpiece device as set forth in claim 1, further comprising a power level indicator on the graphical user interface, the power level indicator being adapted to display a level of power generated by the electromagnetic energy source, wherein:
at least one of the electromagnetic energy control icons comprises a power increase icon that controls an increase in the level of power generated by the electromagnetic energy source; and
at least one other one of the electromagnetic energy control icons comprises a power decrease icon that controls a decrease in the level of power generated by the electromagnetic energy source.

3. The laser handpiece device as set forth in claim 2, wherein:
at least one of the electromagnetic energy control icons comprises an energy mode icon; and the energy mode icon controls a selection one of generating electromagnetic energy in a pulsed mode and generating electromagnetic energy in a continuous wave mode.

4. The laser handpiece device as set forth in claim 3, wherein:
at least one of the electromagnetic energy control icons comprises a pulse length icon that controls a time length of pulses generated by the electromagnetic energy source, the time length being controlled independently of a time interval between pulses; and
the pulse length icon, when touched, causes a pulse length screen to be presented, the pulse length screen comprising:
a pulse length indicator adapted to display a value according to a length of an electromagnetic energy pulse generated by the electromagnetic energy source;
a pulse length increase icon that controls an increase in the length of a pulse generated by the electromagnetic energy source; and
a pulse length decrease icon that controls a decrease in the length of a pulse generated by the electromagnetic energy source.

5. The laser handpiece device as set forth in claim 3, wherein:
at least one of the electromagnetic energy control icons comprises a pulse interval icon that controls a time interval between pulses generated by the electromagnetic energy source, the time interval being controlled independently of a time length of pulses; and
the pulse interval icon, when touched, causes a pulse interval screen to be presented, the pulse interval screen comprising:
a pulse interval indicator adapted to display a value according to a length of a time interval between electromagnetic energy pulses generated by the electromagnetic energy source;
a pulse interval increase icon that controls an increase in the length of the time interval between pulses generated by the electromagnetic energy source; and
a pulse interval decrease icon that controls a decrease in the length of the time interval between pulses generated by the electromagnetic energy source.

6. The laser handpiece device as set forth in claim 3, wherein:
the graphical user interface further comprises a plurality of electromagnetic energy indicator icons adapted to display a plurality of properties of electromagnetic energy generated by the electromagnetic energy source;
the plurality of properties comprise an average power level and a total energy level; and
the display of the average power level is calculated, when in the pulsed mode, according to the level of power generated by the electromagnetic energy source, a pulse length, and a pulse interval.

7. The laser handpiece device as set forth in claim 1, the device further comprising a computer adapted to independently adjust a pulse length and a pulse interval of the pulses of electromagnetic energy according to a user input.

8. The laser handpiece device as set forth in claim 7, wherein the computer comprises:
a processor;
working memory;
program memory;
an interface to the electromagnetic energy source adapted to be controlled by the processor; and
a system bus that communicatively interconnects the processor, working memory, and program memory, the program memory having stored therein a power level software module that causes the processor to receive a power level input from the graphical user interface and to communicate with the interface to the electromagnetic energy source to control a power level of the electromagnetic energy source according to the power level input.

9. The laser handpiece device as set forth in claim 8, wherein:
at least one of the electromagnetic energy control icons comprises a power increase icon;
at least one other one of the electromagnetic energy control icons comprises a power decrease icon;
the power level software module further causes the processor to communicate with the interface to the electromagnetic energy source to control an increase in the power level of the electromagnetic energy source when the power increase icon is pressed; and
the power level software module further causes the processor to communicate with the interface to the electromagnetic energy source to control a decrease in the power level of the electromagnetic energy source when the power decrease icon is pressed.

10. The laser handpiece device as set forth in claim 9, wherein:
at least one of the plurality electromagnetic energy control icons comprises an energy mode icon;
the program memory further has stored therein an energy mode software module that causes the processor to communicate with the interface to the electromagnetic energy source to select one of a pulsed mode and a continuous wave mode of electromagnetic energy generation when the energy mode icon is pressed.

11. The laser handpiece device as set forth in claim 10, wherein:
at least one of the energy control icons comprises a pulse length icon;
the program memory further has stored therein a pulse length software module that, when the processor selects the pulse mode, and when the pulse length icon is pressed, causes the processor to present a pulse length screen on the touchscreen.

12. The laser handpiece device as set forth in claim 11, wherein the pulse length screen comprises a pulse length indicator, a pulse length increase icon, and a pulse length decrease icon, whereby:
the pulse length software module causes the processor to display a value in the pulse length indicator according to a length of pulses generated by the electromagnetic energy source,
the pulse length software module further causes the processor to communicate with the electromagnetic energy source to control an increase in a length of pulses generated by the electromagnetic energy source when the pulse length increase icon is pressed; and
the pulse length software module further causes the processor to communicate with the electromagnetic energy course to control a decrease in the length of pulses generated by the electromagnetic energy source when the pulse length decrease icon is pressed.

13. The laser handpiece device as set forth in claim 12, wherein the graphical user interface further comprises a plurality of electromagnetic energy indicator icons displaying at least one of a plurality of properties of electromagnetic energy generated by the electromagnetic energy source.

14. The laser handpiece device as set forth in claim 13, wherein the plurality of properties comprise an average power level and a total energy level.

15. The laser handpiece device as set forth in claim 14, wherein the power level software module further causes the processor to display the average power level according to the level of power generated by the electromagnetic energy source, the pulse length, and the pulse interval.

16. The laser handpiece device as set forth in claim 10, wherein:
at least one of the energy control icons comprises a pulse interval icon;
the program memory further has stored therein a pulse interval software module that, when the processor selects the pulse mode, and when the pulse interval icon is pressed, causes the processor to present a pulse interval screen on the touchscreen.

17. The laser handpiece device as set forth in claim 16, wherein the pulse interval screen comprises a pulse interval indicator, a pulse interval increase icon, and a pulse interval decrease icon, whereby:
the pulse interval software module causes the processor to display in the pulse interval indicator a value according to a time interval between pulses generated by the electromagnetic energy source,
the pulse interval software module causes the processor to communicate with the electromagnetic energy source to control an increase in the time interval when the pulse interval increase icon is pressed; and
the pulse interval software module causes the processor to communicate with the electromagnetic energy course to control a decrease in the time interval when the pulse interval decrease icon is pressed.

18. A method of controlling the laser handpiece device of claim 1, the method comprising:
presenting the plurality of preset parameter-value combinations to a user on the graphical user interface;
receiving a preset selection from the user on the graphical user interface; and
adjusting an operating mode of the laser handpiece device according to the preset selection.

19. The method as set forth in claim 18, further comprising:
presenting a modification screen to the user on the graphical user interface according to the preset selection;
receiving on the graphical user interface a modification to the selected preset; and
storing the modification as one of the preset parameter-value combinations the modification being stored for future presentation on the graphical user interface during the presenting step.

20. The method as set forth in claim 19, and further comprising controlling an on/off state of an electromagnetic energy source according to input received from a foot switch.

21. The method as set forth in claim 20, wherein the receiving of a modification comprises receiving at least one of an energy mode input, a pulsed energy mode input, a pulse interval input, a pulse length input, a continuous wave mode input, a total energy input, and a power level input.
